(19) United States
(12) Patent Application Publication
(10) Pub. No.: US 2024/0272665 A1
(43) Pub. Date: Aug. 15, 2024

(54) LOW-DROPOUT REGULATOR AND OPERATION METHOD

(71) Applicant: Realtek Semiconductor Corporation, Hsinchu (TW)

(72) Inventor: Yi FENG, Hsinchu (TW)

(21) Appl. No.: 18/408,553

(22) Filed: Jan. 9, 2024

(30) Foreign Application Priority Data
Feb. 9, 2023 (TW) 112104617

(51) Int. Cl. G05F 1/575

(52) U.S. Cl. CPC G05F 1/575

(57) ABSTRACT

A low-dropout regulator includes an amplifier circuit, a power transistor, a feedback circuit, and an accelerator circuit. The amplifier circuit operates based on an input voltage. The amplifier circuit is configured to generate an amplified voltage at a node according to a reference voltage and a feedback voltage. The power transistor is configured to generate an output voltage at an output terminal according to the input voltage and the amplified voltage. The feedback circuit is configured to generate the feedback voltage according to the output voltage. The accelerator circuit is configured to perform an acceleration operation on the output voltage according to a voltage difference in the low-dropout regulator.

### RELATED APPLICATIONS

This application claims priority to Taiwanese Application Serial Number 112104617, filed Feb. 9, 2023, which is herein incorporated by reference.

### BACKGROUND

### Technical Field

The present disclosure relates to technology about low-dropout regulators (LDO). More particularly, the present disclosure relates to a low-dropout regulator with shorter settling time and an operation method thereof.

### Description of Related Art

With developments of technology, various integrated circuits have been developed. However, performance of many integrated circuits still needs to be improved.

For example, in some related approaches, in order to shorten settling time of a low-dropout regulator, the quiescent current of the low-dropout regulator needs to be increased. However, this will increase power consumption. In some other approaches, in order to avoid errors of the load circuit when the low-dropout regulator changes from a light-load state to a heavy-load state, the current of the amplifier circuit needs to be increased or an additional capacitor needs to be disposed in the circuit. However, this will increase power consumption or the circuit area.

### SUMMARY

Some aspects of the present disclosure are to provide a low-dropout regulator. The low-dropout regulator includes an amplifier circuit, a power transistor, a feedback circuit, and an accelerator circuit. The amplifier circuit operates based on an input voltage. The amplifier circuit is configured to generate an amplified voltage at a node according to a reference voltage and a feedback voltage. The power transistor is configured to generate an output voltage at an output terminal according to the input voltage and the amplified voltage. The feedback circuit is configured to generate the feedback voltage according to the output voltage. The accelerator circuit is configured to perform an acceleration operation on the output voltage according to a voltage difference in the low-dropout regulator.

Some aspects of the present disclosure are to provide an operation method of a low-dropout regulator. The operation method includes following operations: generating, by an amplifier circuit, an amplified voltage at a node according to a reference voltage and a feedback voltage; generating, by a power transistor, an output voltage at an output terminal according to the input voltage and the amplified voltage; generating, by a feedback circuit, the feedback voltage according to the output voltage; and performing, by an accelerator circuit, an acceleration operation on the output voltage according to a voltage difference in the low-dropout regulator.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a low-dropout regulator according to some embodiments of the present disclosure.

FIG. 2 is a schematic diagram of an accelerator circuit according to some embodiments of the present disclosure.

FIG. 3 is a schematic diagram of an accelerator circuit according to some embodiments of the present disclosure.

FIG. 4 is a schematic diagram of an accelerator circuit according to some embodiments of the present disclosure.

FIG. 5 is a schematic diagram of an accelerator circuit according to some embodiments of the present disclosure.

FIG. 6 is a schematic diagram of an accelerator circuit according to some embodiments of the present disclosure.

FIG. 7 is a schematic diagram of a low-dropout regulator according to some embodiments of the present disclosure.

FIG. 8 is a schematic diagram of a low-dropout regulator according to some embodiments of the present disclosure.

FIG. 9 is a schematic diagram of a low-dropout regulator according to some embodiments of the present disclosure.

FIG. 10 is a flow diagram of an operation method according to some embodiments of the present disclosure.

### DETAILED DESCRIPTION

In the present disclosure, “connected” or “coupled” may refer to “electrically connected” or “electrically coupled.” “Connected” or “coupled” may also refer to operations or actions between two or more elements.

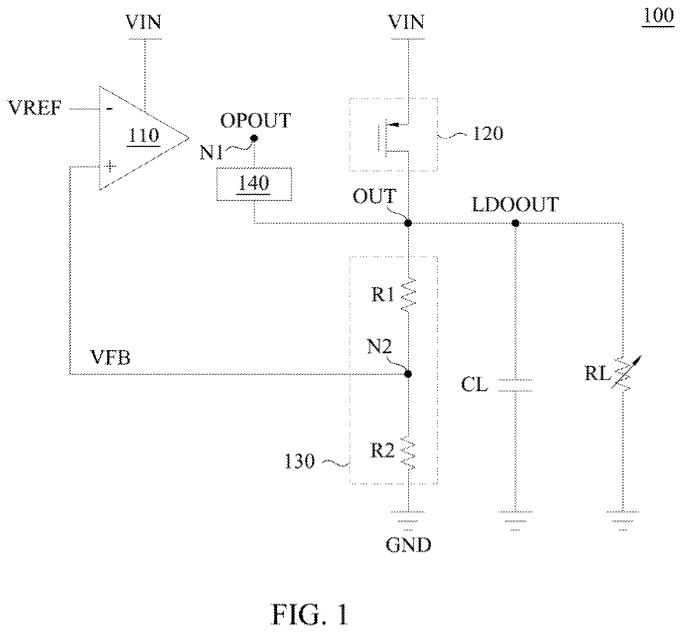

Reference is made to FIG. 1. FIG. 1 is a schematic diagram of a low-dropout regulator 100 according to some embodiments of the present disclosure.

The low-dropout regulator 100 includes an amplifier circuit 110, a power transistor 120, a feedback circuit 130, and an accelerator circuit 140.

The amplifier circuit 110 operates based on an input voltage VIN, and generates an amplified voltage OPOUT at a node N1 according to a reference voltage VREF and a feedback voltage VFB. As illustrated in FIG. 1, the amplifier circuit 110 includes a positive input terminal, a negative input terminal, and an output terminal. The negative input terminal of the amplifier circuit 110 receives the reference voltage VREF. The positive input terminal of the amplifier circuit 110 receives the feedback voltage VFB from the feedback circuit 130. The amplifier circuit 110 generates the amplified voltage OPOUT at its output terminal (i.e., a node N1).

The power transistor 120 is coupled to the amplifier circuit 110 and generates an output voltage LDOOUT at an output terminal OUT according to the input voltage VIN and the amplified voltage OPOUT. As illustrated in FIG. 1, the power transistor 120 is a P-type transistor. A first terminal of the power transistor 120 receives the input voltage VIN. A control terminal of the power transistor 120 receives the amplified voltage OPOUT and the power transistor 120 is controlled by the amplified voltage OPOUT to adjust its conductance such that the output voltage LDOOUT is generated at a second terminal of the power transistor 120 (i.e., the output terminal OUT of the low-dropout regulator 100). In an embodiment, the power transistor 120 can be implemented by a power metal oxide semiconductor field effect transistor (MOSFET).

The feedback circuit 130 is coupled to the power transistor 120 and generates the feedback voltage VFB according to the output voltage LDOOUT. As illustrated in FIG. 1, the feedback circuit 130 includes a resistor R1 and a resistor R2. A first terminal of the resistor R1 is coupled to the output terminal OUT. A second terminal of the resistor R1 is coupled to a first terminal of the resistor R2. A second terminal of the resistor R2 is coupled to a ground terminal GND. The resistor R1 and the resistor R2 form a voltage divider circuit. According to the output voltage LDOOUT and resistance values of the resistor R1 and the resistor R2, the feedback voltage VFB is generated at a node N2 between the resistor R1 and the resistor R2.

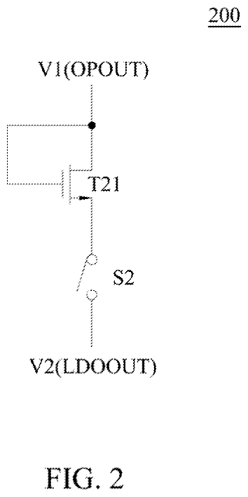

The accelerator circuit 140 is coupled between the amplifier circuit 110 and the output terminal OUT. As illustrated in FIG. 1, the accelerator circuit 140 is coupled between the node N1 and the output terminal OUT to perform an acceleration operation on the output voltage LDOOUT according to a voltage difference between the amplified voltage OPOUT and the output voltage LDOOUT. The details about the accelerator circuit 140 are described in following paragraphs with reference to FIG. 2 to FIG. 6.

In addition, FIG. 1 also shows a load resistor RL and a load capacitor CL. The load resistor RL and the load capacitor CL are contributed by a load coupled to the output terminal OUT.

References are made to FIG. 1 and FIG. 2. FIG. 2 is a schematic diagram of an accelerator circuit 200 according to some embodiments of the present disclosure. In some embodiments, the accelerator circuit 140 in FIG. 1 can be implemented by the accelerator circuit 200 in FIG. 2.

The accelerator circuit 200 includes a transistor T21 and an accelerator switch S2. As illustrated in FIG. 2, the transistor T21 is an N-type transistor and is in a diode-connected form. A first terminal of the transistor T21 is coupled to a first voltage V1 and is coupled to a control terminal of the transistor T21. A second terminal of the transistor T21 is coupled to a first terminal of the accelerator switch S2 in series. A second terminal of the accelerator switch S2 is coupled to a second voltage V2.

In practical applications, when the amplifier circuit 110 is turned off, the accelerator switch S2 is turned off. When the amplifier circuit 110 is turned on, the accelerator switch S2 is turned on. In other words, a control circuit (not shown) can be used to send one same control signal to both of the amplifier circuit 110 and the accelerator switch S2 to simultaneously control the amplifier circuit 110 and the accelerator switch S2. In addition, in a situation that the accelerator switch S2 is turned on, when a voltage difference between the first voltage V1 and the second voltage V2 is greater, the accelerator circuit 200 has a lower resistance. When the voltage difference between the first voltage V1 and the second voltage V2 is less, the accelerator circuit 200 has a higher resistance. In some embodiments, when the amplifier circuit 110 is turned off, the control circuit (not shown) couples gate terminals of inner transistors in the amplifier circuit 110 to the input voltage VIN or to the ground terminal GND to turn off the amplifier circuit 110 to avoid leakage current.

Then, references are made to FIG. 1 and FIG. 2. It is assumed that the accelerator circuit 200 in FIG. 2 is applied to be the accelerator circuit 140 in FIG. 1, the first voltage V1 is the amplified voltage OPOUT and the second voltage V2 is the output voltage LDOOUT. As described above, when the amplifier circuit 110 is turned off, the accelerator switch S2 is turned off. Thus, the accelerator circuit 200 does not work. The amplified voltage OPOUT is pulled to the input voltage VIN (the power transistor 120 is turned off to avoid leakage) and the output voltage LDOOUT is equal to a ground voltage. When the amplifier circuit 110 is turned on, the accelerator switch S2 is turned on. Since the voltage difference between the amplified voltage OPOUT and the output voltage LDOOUT is greater than or equal to a threshold voltage of the transistor T21, the transistor T21 is turned on. Since the accelerator switch S2 and the transistor T21 are turned on, the accelerator circuit 20 can provide a path from the amplified voltage OPOUT to the output voltage LDOOUT such that the amplified voltage OPOUT decreases rapidly and the output voltage LDOOUT increases rapidly. When the amplified voltage OPOUT decreases rapidly to an appropriate voltage (e.g., when the amplified voltage OPOUT is equal to the input voltage VIN minus the threshold voltage of the power transistor 120), the power transistor 120 can be turned on rapidly such that the output voltage LDOOUT increases rapidly to enter a steady state. This can shorten the settling time of the low-dropout regulator 100.

Until the voltage difference between the amplified voltage OPOUT and the output voltage LDOOUT is less than the threshold voltage of the transistor T21, the transistor T21 is turned off. At this time, the path from the amplified voltage OPOUT to the output voltage LDOOUT is turned off.

In addition, after the low-dropout regulator 100 enters the steady state (the accelerator switch S2 is turned on), if the load state changes form a light-load state to a heavy-load state, the output voltage LDOOUT decreases. When the voltage difference between the amplified voltage OPOUT and the output voltage LDOOUT is greater than or equal to the threshold voltage of the threshold voltage of the transistor T21, the transistor T21 is turned on again. Accordingly, the accelerator circuit 200 can provide the path from the amplified voltage OPOUT to the output voltage LDOOUT again such that the amplified voltage OPOUT decreases rapidly again and the output voltage LDOOUT increases rapidly again to avoid the output voltage LDOOUT falling too much.

In some related approaches, in order to shorten settling time of a low-dropout regulator, the quiescent current of the low-dropout regulator needs to be increased. However, this will increase power consumption. In some other approaches, in order to avoid errors of the load circuit when the low-dropout regulator changes from a light-load state to a heavy-load state, the current of the amplifier circuit needs to be increased or an additional capacitor needs to be disposed in the circuit. However, this will increase power consumption or the circuit area.

Compared to aforementioned related approaches, in the present disclosure, by setting the accelerator circuit 140, the settling time of the low-dropout regulator 100 can be shortened and the load circuit can operate correctly without excessively increasing the power consumption of the overall circuit or increasing the circuit area when the low-dropout regulator 100 changes from a light-load state to a heavy-load state.

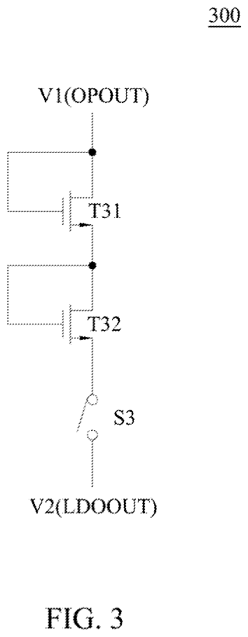

Reference is made to FIG. 3. FIG. 3 is a schematic diagram of an accelerator circuit 300 according to some embodiments of the present disclosure. In some embodiments, the accelerator circuit 140 in FIG. 1 can be implemented by the accelerator circuit 300 in FIG. 3.

The accelerator circuit 300 includes a transistor T31, a transistor T32, and an accelerator switch S3. As illustrated in FIG. 3, the transistor T31 and the transistor T32 are N-type transistors (same type) and are in the diode-connected form. A first terminal of the transistor T31 is coupled to the first voltage V1 and coupled to a control terminal of the transistor T31. A second terminal of the transistor T31 is coupled to a first terminal of the transistor T32 and a control terminal of the transistor T32. A second terminal of the transistor T32 is coupled to a first terminal of the accelerator switch S3 in series. A second terminal of the accelerator switch S3 is coupled to the second voltage V2.

Operations of the accelerator circuit 300 are similar to operations of the accelerator circuit 200 in FIG. 2. One of main differences between the accelerator circuit 300 and the accelerator circuit 200 is that when the voltage difference between the first voltage V1 and the second voltage V2 is less than a sum of threshold voltages of the transistor T31 and the transistor T32, the accelerator circuit 300 is still turned off even if the accelerator switch S3 is turned on.

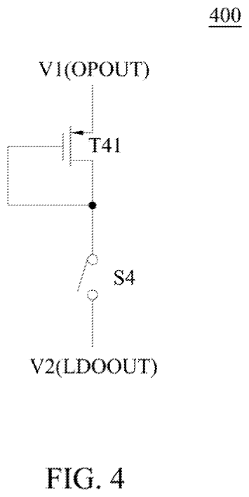

Reference is made to FIG. 4. FIG. 4 is a schematic diagram of an accelerator circuit 400 according to some embodiments of the present disclosure. In some embodiments, the accelerator circuit 140 in FIG. 1 can be implemented by the accelerator circuit 400 in FIG. 4.

The accelerator circuit 400 includes a transistor T41 and an accelerator switch S4. As illustrated in FIG. 4, the transistor T41 is a P-type transistor and is in the diode-connected form. A first terminal of the transistor T41 is coupled to the first voltage V1. A second terminal of the transistor T41 is coupled to a control terminal of the transistor T41. The second terminal of the transistor T41 is further coupled to a first terminal of the accelerator switch S4 in series. A second terminal of the accelerator switch S4 is coupled to the second voltage V2.

Operations of the accelerator circuit 400 are similar to operations of the accelerator circuit 200 in FIG. 2. One of main differences between the accelerator circuit 400 and the accelerator circuit 200 is that when the voltage difference between the first voltage V1 and the second voltage V2 is less than a threshold voltage of the of the transistor T41, the accelerator circuit 400 is still turned off even if the accelerator switch S4 is turned on.

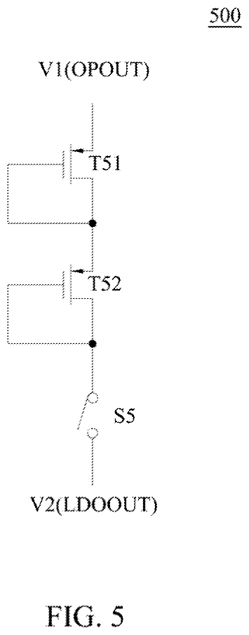

Reference is made to FIG. 5. FIG. 5 is a schematic diagram of an accelerator circuit 500 according to some embodiments of the present disclosure. In some embodiments, the accelerator circuit 140 in FIG. 1 can be implemented by the accelerator circuit 500 in FIG. 5.

The accelerator circuit 500 includes a transistor T51, a transistor T52, and an accelerator switch S5. As illustrated in FIG. 5, the transistor T51 and the transistor T52 are P-type (same type) transistors and are in the diode-connected form. A first terminal of the transistor T51 is coupled to the first voltage V1. A control terminal of the transistor T51 is coupled to a second terminal of the transistor T51 and a first terminal of the transistor T52. A control terminal of the transistor T52 is coupled to a second terminal of the transistor T52 and is coupled to a first terminal of the accelerator switch S5 in series. A second terminal of the accelerator switch S5 is coupled to the second voltage V2.

Operations of the accelerator circuit 500 are similar to operations of the accelerator circuit 200 in FIG. 2. One of main differences between the accelerator circuit 500 and the accelerator circuit 200 is that when the voltage difference between the first voltage V1 and the second voltage V2 is less than a sum of threshold voltages of the transistor T51 and the transistor T52, the accelerator circuit 500 is still turned off even if the accelerator switch S5 is turned on.

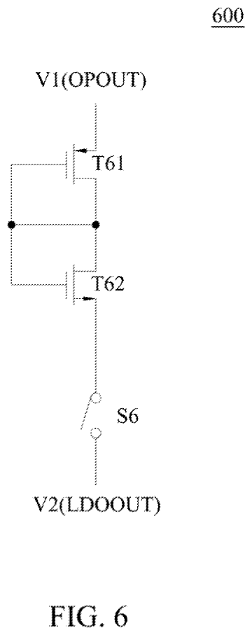

Reference is made to FIG. 6. FIG. 6 is a schematic diagram of an accelerator circuit 600 according to some embodiments of the present disclosure. In some embodiments, the accelerator circuit 140 in FIG. 1 can be implemented by the accelerator circuit 600 in FIG. 6.

The accelerator circuit 600 includes a transistor T61, a transistor T62, and an accelerator switch S6. As illustrated in FIG. 6, the transistor T61 is a P-type transistor and the transistor T62 is an N-type transistor (different types) and are in the diode-connected form. A first terminal of the transistor T61 is coupled to the first voltage V1. A control terminal of the transistor T61 is coupled to a second terminal of the transistor T61, a first terminal of the transistor T62, and a control terminal of the transistor T62. A second terminal of the transistor T62 is coupled to a first terminal of the accelerator switch S6 in series. A second terminal of the accelerator switch S6 is coupled to the second voltage V2.

Operations of the accelerator circuit 600 are similar to operations of the accelerator circuit 200 in FIG. 2. One of main differences between the accelerator circuit 600 and the accelerator circuit 200 is that when the voltage difference between the first voltage V1 and the second voltage V2 is less than a sum of threshold voltages of the transistor T61 and the transistor T62, the accelerator circuit 600 is still turned off even if the accelerator switch S6 is turned on.

In the embodiments of FIG. 2 to FIG. 6, the transistor T21, the transistor T31, the transistor T32, the transistor T41, the transistor T51, the transistor T52, the transistor T61, and the transistor T62 are implemented by metal oxide semiconductor field effect transistors (MOSFET). However, in some other embodiments, the transistor T21, the transistor T31, the transistor T32, the transistor T41, the transistor T51, the transistor T52, the transistor T61, the transistor T62 can be implemented by bipolar transistors (BJT).

In some embodiments, the accelerator switch S2, the accelerator switch S3, the accelerator switch S4, the accelerator switch S5, and the accelerator switch S6 can be implemented by MOSFETs.

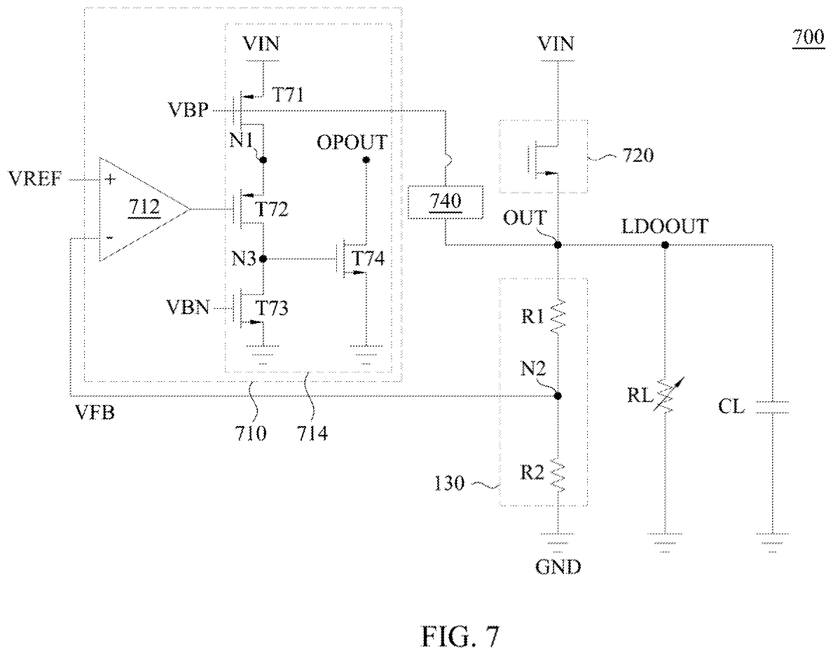

Reference is made to FIG. 7. FIG. 7 is a schematic diagram of a low-dropout regulator 700 according to some embodiments of the present disclosure.

An amplifier circuit 710 includes an error amplifier 712 and a buffer circuit 714.

A first terminal of the error amplifier 712 receives the reference voltage VREF. A second terminal of the error amplifier 712 receives the feedback voltage VFB. An output terminal of the error amplifier 712 is coupled to the buffer circuit 714.

The buffer circuit 714 includes a transistor T71, a transistor T72, a transistor T73, and a transistor T74. The transistor T71 and the transistor T72 are P-type transistors. The transistor T73 and the transistor T74 are N-type transistors. A first terminal of the transistor T71 receives the input voltage VIN. A second terminal of the transistor T71 is coupled to the node N1. A control terminal of the transistor T71 is controlled by a bias voltage VBP to provide a bias current. The transistor T72 is coupled between the node N1 and a node N3 and controlled by an output of the error amplifier 712 to adjust its conductance. The transistor T73 is coupled between the node N3 and the ground terminal GND and controlled by a bias voltage VBN to provide a bias current. The transistor T74 is coupled between the node N1 and the ground terminal GND and controlled by a voltage at the node N3 to adjust its conductance.

A power transistor 720 is coupled to the amplifier circuit 710 and generates the output voltage LDOOUT at the output terminal OUT according to the input voltage VIN and the amplified voltage OPOUT. As illustrated in FIG. 7, the power transistor 720 is an N-type transistor.

An accelerator circuit 740 is coupled between the control terminal of the transistor T71 and the output terminal OUT to perform the acceleration operation according to a voltage difference between the bias voltage VBP at the control terminal of the transistor T71 and the output voltage LDOOUT.

References are made to FIG. 2 and FIG. 7. If the accelerator circuit 200 is applied to the accelerator circuit 740 in FIG. 7, the first voltage V1 in FIG. 2 is the bias voltage VBP and the second voltage V2 in FIG. 2 is the output voltage LDOOUT. When the amplifier circuit 710 is turned off, the accelerator switch S2 is turned off. Thus, the accelerator circuit 200 does not work. At this time, the bias voltage VBP is equal to the input voltage VIN. The amplified voltage OPOUT and the output voltage LDOOUT are equal to the ground voltage. When the amplifier circuit 710 is turned on, the accelerator switch S2 is turned on. Since a voltage difference between the bias voltage VBP and the output voltage LDOOUT is greater than or equal to the threshold voltage of the transistor T21, the transistor T21 is turned on. Since the accelerator switch S2 and the transistor T21 are turned on, the accelerator circuit 200 can provide a path from the bias voltage VBP to the output voltage LDOOUT such that the bias voltage VBP decreases rapidly and the output voltage LDOOUT increases rapidly. Since the bias voltage VBP decreases rapidly, the amplified voltage OPOUT (through the transistor T71) increases rapidly to turn on the power transistor 720 rapidly such that the output voltage LDOOUT increases rapidly. Thus, the settling time of the low-dropout regulator 700 can be shortened.

When the accelerator circuit 740 is implemented by the accelerator circuit 300, 400, 500, or 600 in FIG. 3 to FIG. 6, the first voltage V1 in FIG. 3 to FIG. 6 is the bias voltage VBP, and the second voltage V2 in FIG. 3 to FIG. 6 is the output voltage LDOOUT.

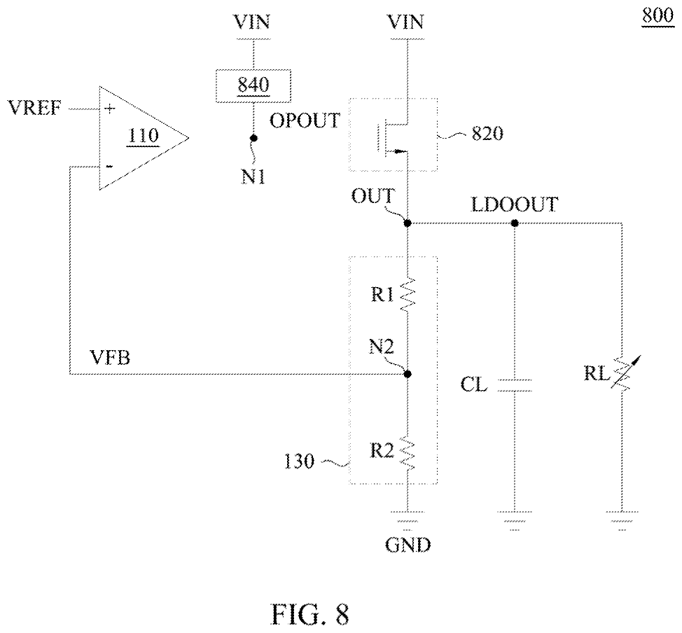

Reference is made to FIG. 8. FIG. 8 is a schematic diagram of a low-dropout regulator 800 according to some embodiments of the present disclosure.

Some of main differences between the low-dropout regulator 800 and the low-dropout regulator 100 in FIG. 1 are that a power transistor 820 is an N-type transistor and an accelerator circuit 840 is coupled between the input voltage VIN and the node N1. The accelerator circuit 840 can provide a path from the input voltage VIN to the amplified voltage OPOUT, and the output voltage LDOOUT can increase rapidly according to a voltage difference between the input voltage VIN and the amplified voltage OPOUT. When the amplified voltage OPOUT increases rapidly to an appropriate voltage, the power transistor 820 can be turned on rapidly such that the output voltage LDOOUT increases rapidly to enter a steady state. Thus, the settling time of the low-dropout regulator 800 can be shortened.

When the accelerator circuit 840 is implemented by the accelerator circuit 200, 300, 400, 500, or 600 in FIG. 2 to FIG. 6, the first voltage V1 in FIG. 2 to FIG. 6 is the input voltage VIN, and the second voltage V2 in FIG. 2 to FIG. 6 is the amplified voltage OPOUT.

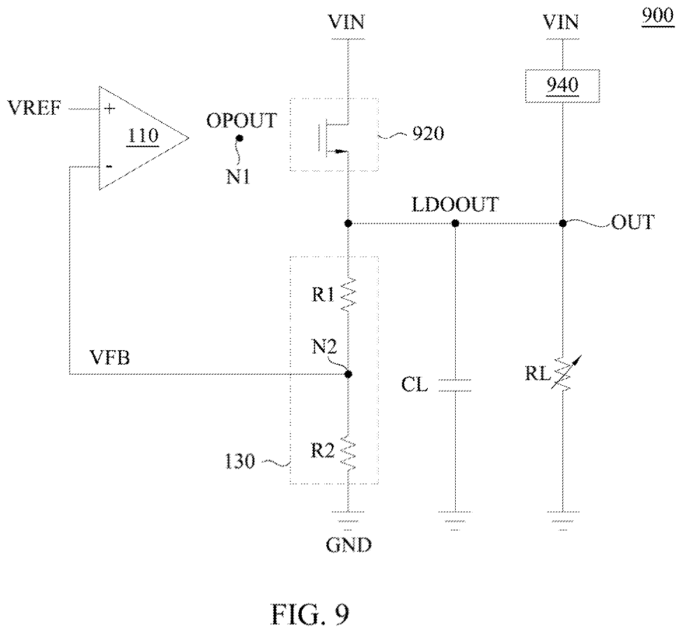

Reference is made to FIG. 9. FIG. 9 is a schematic diagram of a low-dropout regulator 900 according to some embodiments of the present disclosure.

Some of main differences between the low-dropout regulator 900 and the low-dropout regulator 100 in FIG. 1 are that a power transistor 920 is an N-type transistor and an accelerator circuit 940 is coupled between the input voltage VIN and the output terminal OUT. The accelerator circuit 940 can provide a path from the input voltage VIN to the output voltage LDOOUT, and the output voltage LDOOUT can increase rapidly according to a voltage difference between the input voltage VIN and the output voltage LDOOUT to enter a steady state. Thus, the settling time of the low-dropout regulator 900 can be shortened.

When the accelerator circuit 940 is implemented by the accelerator circuit 200, 300, 400, 500, or 600 in FIG. 2 to FIG. 6, the first voltage V1 in FIG. 2 to FIG. 6 is the input voltage VIN, and the second voltage V2 in FIG. 2 to FIG. 6 is the output voltage LDOOUT.

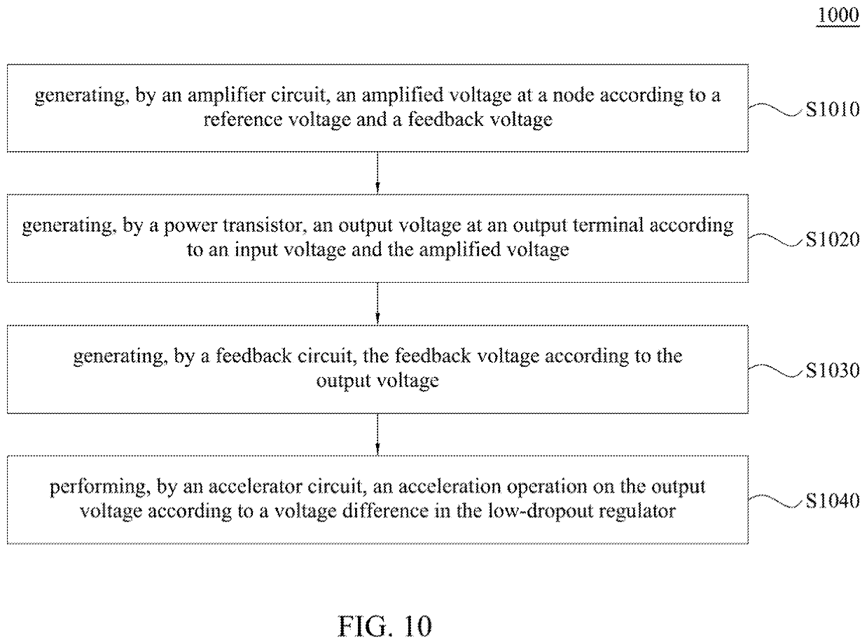

Reference is made to FIG. 10. FIG. 10 is a flow diagram of an operation method 1000 according to some embodiments of the present disclosure.

For better understanding, following paragraphs are described with reference to the low-dropout regulator 100 in FIG. 1, but the present disclosure is not limited to the low-dropout regulator 100 in FIG. 1.

As illustrated in FIG. 10, the operation method 1000 includes operation S1010, operation S1020, operation S1030, and operation S1040.

In operation S1010, the amplifier circuit 110 generates the amplified voltage OPOUT at the node N1 according to the reference voltage VREF and the feedback voltage VFB.

In operation S1020, the power transistor 120 generates the output voltage LDOOUT at the output terminal OUT according to the input voltage VIN and the amplified voltage OPOUT.

In operation S1030, the feedback circuit 130 generates the feedback voltage VFB according to the output voltage LDOOUT.

In operation S1040, the accelerator circuit 140 performs the acceleration operation on the output voltage LDOOUT according to a voltage difference in the low-dropout regulator 100. In the example in FIG. 1, the voltage difference is the voltage difference between the amplified voltage OPOUT and the output voltage LDOOUT.

The details about the aforementioned operations are described in the embodiments above, so they are not described herein again.

As described above, by setting the accelerator circuit in the present disclosure, the settling time of the low-dropout regulator can be shortened and the load circuit can operate correctly without excessively increasing the power consumption of the overall circuit or increasing the circuit area when the low-dropout regulator changes from the light-load state to the heavy-load state.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A low-dropout regulator, comprising:
an amplifier circuit operating based on an input voltage and configured to generate an amplified voltage at a node according to a reference voltage and a feedback voltage;
a power transistor configured to generate an output voltage at an output terminal according to the input voltage and the amplified voltage;
a feedback circuit configured to generate the feedback voltage according to the output voltage; and
an accelerator circuit configured to perform an acceleration operation on the output voltage according to a voltage difference in the low-dropout regulator.

2. The low-dropout regulator of claim 1, wherein the accelerator circuit comprises:
a first transistor being in a diode-connected form; and
an accelerator switch coupled to the first transistor in series,
wherein when the accelerator circuit is turned off, the accelerator switch is turned off, wherein when the accelerator circuit is turned on, the accelerator switch is turned on.

3. The low-dropout regulator of claim 2, wherein the power transistor is a P-type transistor.

4. The low-dropout regulator of claim 2, wherein the accelerator circuit is coupled between the node and the output terminal and configured to perform the acceleration operation according to the voltage difference between the amplified voltage and the output voltage.

5. The low-dropout regulator of claim 3, wherein the first transistor is an N-type transistor.

6. The low-dropout regulator of claim 3, wherein the first transistor is a P-type transistor.

7. The low-dropout regulator of claim 2, wherein the accelerator circuit further comprises:
a second transistor coupled to the first transistor in series and being in the diode-connected form.

8. The low-dropout regulator of claim 7, wherein a type of the first transistor is the same to a type of the second transistor.

9. The low-dropout regulator of claim 7, wherein a type of the first transistor is different from a type of the second transistor.

10. The low-dropout regulator of claim 2, wherein the power transistor is an N-type transistor.

11. The low-dropout regulator of claim 2, wherein the amplifier circuit comprises:
a transistor, wherein the accelerator circuit is coupled between a control terminal of the transistor and the output terminal and configured to perform the acceleration operation according to the voltage difference between a bias voltage at the control terminal and the output voltage.

12. The low-dropout regulator of claim 2, wherein the accelerator circuit is coupled between the input voltage and the node and configured to perform the acceleration operation according to the voltage difference between the input voltage and the amplified voltage.

13. The low-dropout regulator of claim 2, wherein the accelerator circuit is coupled between the input voltage and the output terminal and configured to perform the acceleration operation according to the voltage difference between the input voltage and the output voltage.

14. The low-dropout regulator of claim 10, wherein the first transistor is an N-type transistor.

15. The low-dropout regulator of claim 10, wherein the first transistor is a P-type transistor.

16. The low-dropout regulator of claim 10, wherein the accelerator circuit further comprises:
a second transistor coupled to the first transistor in series and being in the diode-connected form.

17. The low-dropout regulator of claim 16, wherein a type of the first transistor is the same to a type of the second transistor.

18. The low-dropout regulator of claim 16, wherein a type of the first transistor is different from a type of the second transistor.

19. An operation method of a low-dropout regulator, wherein the operation method comprises:
generating, by an amplifier circuit, an amplified voltage at a node according to a reference voltage and a feedback voltage;
generating, by a power transistor, an output voltage at an output terminal according to an input voltage and the amplified voltage;
generating, by a feedback circuit, the feedback voltage according to the output voltage; and
performing, by an accelerator circuit, an acceleration operation on the output voltage according to a voltage difference in the low-dropout regulator.

20. The operation method of the low-dropout regulator of claim 19, further comprising:
turning off an accelerator switch when the accelerator circuit is turned off; and
turning on the accelerator switch when the accelerator circuit is turned on,
wherein the accelerator circuit comprises the accelerator switch and a transistor, the transistor is in a diode-connected form, and the transistor is coupled to the accelerator switch in series.
